(19) United States
(12) Patent Application Publication
(10) Pub. No.: US 2019/0143567 A1
(43) Pub. Date: May 16, 2019

(54) HARD CASE APPARATUS AND METHOD FOR MANUFACTURING THE SAME

(71) Applicant: Panji, LLC, Telluride, CO (US)

(72) Inventors: Hanna Pernefeldt, Ridgway, CO (US); Joshua Buck Jacobs, Ridgway, CO (US)

(21) Appl. No.: 16/192,281

(22) Filed: Nov. 15, 2018

Related U.S. Application Data
(60) Provisional application No. 62/587,432, filed on Nov. 16, 2017.

(51) Int. Cl. B29C 41/00; B29C 41/22; B29C 70/44

(52) U.S. Cl. CPC B29C 41/003; B29K 2001/00; B29C 70/44; B29C 41/22

(57) ABSTRACT

The disclosure provides, in certain embodiments, a method of manufacturing hard surface apparatus using natural and/or recycled fibrous materials. The method described in certain embodiments allows the creation of a protective case, including, but not limited to, protective containers for a myriad of uses, such as hard cases, bags, backpacks, briefcases, instrument cases, car toppers, snowboard carriers, fishing rod cases, laptop cases, phone cases, and the like. In certain embodiments, the method described herein allows the creation of hard surface apparatuses such as kayaks and canoes, flooring and tiles, bathtubs and sinks, kitchen ware, and the like.

### CROSS-REFERENCE TO RELATED APPLICATIONS

This application claims priority to co-pending U.S. Provisional Patent Application No. 62/587,432, filed on Nov. 16, 2017, the entire content of which is incorporated herein by reference.

### FIELD OF THE INVENTION

Embodiments of the present invention are generally related to a hard surface apparatus, such as a protective case, and methods of manufacturing the hard surface apparatus.

### BACKGROUND OF THE INVENTION

Protective cases are available for shielding valuable items, personal effects, and the like. Protective cases can be used for transporting a number of items, for example, including, but not limited to, clothing, toiletries, computers, musical instruments, electronic equipment, and camera equipment. Protective cases are particularly important for more sensitive items such as musical instruments and electronic equipment, as these items can break or malfunction with impact forces.

Generally, the strength and durability of a hard case is an important consideration for selecting a protective case. Cases having a hard exterior surface provide protection against impact, while maintaining the integrity of the contents of the case. Cases having a rigid exterior surface allow their content to withstand compressive forces and impact forces.

Another consideration that may be important in selecting a protective case is its weight. In particular, protective cases having a lower weight can be advantageous compared to cases with a higher weight. Protective cases with a lower weight can be less costly to ship and can be easier for a user to lift and move. When protective cases are used as carrying cases for travel, lightweight protective cases are particularly advantageous to allow a user to transport items for a longer duration and/or longer distance before the user potentially feels fatigue.

Additionally, an important consideration in selecting a protective case is found in a case's ergonomics. Certain backpacks lack an ergonomic region that provides comfort to a user's back. These certain bags can be uncomfortable for wearers of these bags, and not healthy for the spine when wearing for long periods of time. Such bags include, for example, clamshell design with curved shapes or completely flat shapes. Better ergonomics allows for greater comfort and efficiency in transporting a case. Better ergonomics also allows a user to carry a case for longer durations and/or longer distances, in addition to being healthier for the spine.

Currently available cases having a hard exterior surface may use materials that are not environmentally friendly. For example, certain cases are primarily made of petrochemical compounds such as ABS plastic, polycarbonate, and polypropylene (e.g. Tegris®). In currently available cases, the type of petrochemical compound used and the design of the case can affect the durability and the weight of the case.

Certain hard cases that use petrochemical compounds are durable and rigid. However, durable and rigid cases tend to use greater amounts of environmentally unfriendly materials to reinforce the case. In order to achieve this durability and rigidity, these cases may also be heavier. Lighter cases are also available. However, lighter cases may have thinner walls, which sacrifices the rigidity of the case. Cases having thinner walls tend to be more pliable. This increased pliability often affects the case's capability to protect its contents, as the walls can deform.

### SUMMARY OF THE INVENTION

Therefore, there is a general need for a hard case apparatus that provides a strong, durable, and rigid outer surface that further includes materials that are more environmentally friendly, including but not limited to recycled and/or natural fibrous materials such as cardboard, cardboard products, paper, paper products, textiles, and loose or woven fibers such as basalt, flax, kenaf, coir, jute, bamboo, or hemp. There is a need for a hard case apparatus that provides a heavy-duty construction that is impact-resistant and has compression-resistant qualities, while being more environmentally friendly.

There is a need for a hard surface apparatus that reuses or recycles materials that leads to lower use and dependency on petrochemicals. There is a need for a hard surface apparatus that uses recycled materials that further incentivize people to reuse and recycle materials. There is a need for a hard surface apparatus that actively supports the currently existing recycling infrastructure in a proactive manner.

There is a need for a hard surface apparatus that has a unique and novel combination of coating treatments that strengthens an outer surface, and inner surface of the hard surface apparatus, while also keeping it shatter resistant.

There is also a need for a method for manufacturing a hard surface apparatus that incorporates the advantages as described herein.

Certain embodiments of the present disclosure include a hard case surface, and a method for manufacturing such hard surface apparatus. Certain embodiments of the present disclosure include a manufacturing method that allows manufacturing of a hard surface apparatus using fibrous materials. The method described in certain embodiments allows the creation of a hardcase, including, but not limited to, protective containers for a myriad of uses, such as bags, backpacks, briefcases, instrument cases, car toppers, snowboard carriers, fishing rod cases, laptop cases, and phone cases. In certain embodiments, the method described herein allows the creation of hard surface apparatuses such as kayaks and canoes, flooring and tiles, kitchen ware, sinks and bathtubs, and the like.

Certain embodiments of the present disclosure comprise a hard case for storing and transporting items. Certain embodiments of the invention are designed to hold items including, but not limited to, instruments, luggage, personal items, and computer devices. Certain embodiments of the present disclosure include a collection of bags offering eco-friendly hardshell bags, which are an alternative to bags made of other materials. Certain embodiments of the invention include eco-friendly, durable, and functional bags. Certain embodiments include straps to allow holding the hard case as a backpack, or in some situations, straps to allow holding the hard case as a brief case. Hardware elements such as shoulder straps, chest straps, hip belt, and handles are used in certain embodiments. In certain embodiments, the use of a hip belt supports healthy distribution of total weight, increases comfort, and allows a user to carry a hard case for longer distances and/or longer durations. Certain embodiments include wheels or casters coupled to the hard case to facilitate rolling the hard case along the ground.

Certain embodiments of the present disclosure include a manufacturing method using fibers to manufacture a hard surface apparatus. In certain embodiments, a combination of materials is used, including, but not limited to, cardboard, paper, textiles, and loose or woven fibers such as basalt, flax, kenaf, coir, jute, bamboo, or hemp.

These materials can be processed in various ways. In certain embodiments, materials include recycled materials, such as recycled cardboard, recycled paper, as well as recycled consumable products including, for example, food packaging, textiles, fibers, and the like. In certain embodiments, a blend includes a fiber composite blend such as a paper pulp blend. In certain embodiments, the blended materials are molded to provide a mache or slurry. In certain embodiments, the method includes a mold that receives a blend, which allows the mache or slurry to acquire the shape of the mold. The mache or slurry is dried on the mold using a number of drying means. In certain embodiments, the molded material provides rigidity, structure, and aesthetic qualities to a hard case apparatus.

In certain embodiments, the molded material is reinforced with at least one layer. In certain embodiments, a layer includes, but is not limited to, one or more coatings of resins, terpenes, polymers, epoxy resins, polyester epoxies, polymer coating, and polyepoxides. In certain embodiments, a first layer provides a hardened layer to the hard case apparatus. In certain embodiments, the molded material is further reinforced with a second layer. In certain embodiments, a second layer provides the hard case apparatus a flexible layer. In certain embodiments, a second layer provides a flexible quality that complements the rigidity of the molded material, the first layer, and a third layer. In certain embodiments, such flexible layer provides a flexible sub-layer to certain other layers. In certain embodiments, an optional fourth layer provides a flexible layer.

Thus, the invention may provide, in one aspect, a method for manufacturing a hard surface apparatus. The method may include processing a material comprising a cellulose-base, wherein the processing step comprises fragmenting the material. The method may also include blending the material, adding a solvent and mixing the solvent with the material to create a slurry, molding the slurry on a first mold, drying said slurry on the first mold to create a first molded material, applying a first layer to the first molded material, and applying a second layer to the first molded material.

The invention may provide, in another aspect, a method for manufacturing a protective case. The method may include processing a recycled material comprising a cellulose-base, adding a solvent and mixing the solvent with the material to create a slurry, molding the slurry on a first mold to create a first molded material, applying a first layer to the first molded material, and applying a second layer to the first molded material.

The invention may provide, in another aspect, a method for manufacturing a protective case. The method may include forming a first shell and a second shell, wherein forming each of the first and second shells includes infusing a natural fiber base material with an epoxy resin to form an uncured composite material, shaping the uncured composite material, and curing the uncured composite material at an elevated temperature to form a cured composite material. The method may also include after curing, coupling the first shell to the second shell.

These and other aspects will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention, nor its uses. The present invention is set forth in various levels of detail in this Summary, as well as in the attached drawings and the detailed description below, and no limitation as to the scope of the present invention is intended to either the inclusion or non-inclusion of elements, components, processes, etc. in this Summary. Additional aspects of the present invention will become more readily apparent from the detailed description, particularly when taken together with the drawings.

### BRIEF DESCRIPTION OF THE DRAWINGS

FIG. 1: A flow chart showing a manufacturing method in certain embodiments of the invention.

FIG. 2: A flow chart showing a manufacturing method in certain embodiments of the invention.

FIG. 3A: Side view of a hard case apparatus in certain embodiments.

FIG. 3B: Perspective view of a hard case apparatus in certain embodiments.

FIG. 3C: Side sectional close-up view of an opening of a hard case apparatus in certain embodiments.

FIG. 4A: A side sectional view of a shell portion in certain embodiments.

FIG. 4B: A close up sectional view of a shell portion in certain embodiments.

FIG. 4C: A close up sectional view of a shell portion in certain embodiments.

FIG. 5A: A side view of a hard case apparatus in certain embodiments.

FIG. 5B: A side view of a hard case apparatus in certain embodiments.

FIG. 6: A hard case apparatus in an open configuration, in certain embodiments of the invention.

FIG. 7: A hard case apparatus in an open configuration, in certain embodiments of the invention.

FIG. 8: A perspective view of a mold in certain embodiments.

FIG. 9A: A perspective view of a shell portion in certain embodiments.

FIG. 9B: A perspective view of a mold in certain embodiments.

FIG. 10: A flow chart showing a manufacturing method in certain embodiments of the invention.

### DETAILED DESCRIPTION

Certain embodiments of the invention include a manufacturing method that uses fibers to manufacture a hard case apparatus. In certain embodiments, a blend is created using a number of materials. In certain embodiments, these materials include natural, fibrous materials. In certain embodiments, materials, including, but not limited to cardboard, cardboard products, paper, paper products, textiles, and loose or woven fibers such as basalt, flax, kenaf, coir, jute, bamboo, or hemp are processed. In certain embodiments, such materials include recycled products, such as recycled cardboard, recycled paper, as well as recycled consumable products including, for example, food packaging, product packaging, and the like. The use of natural and recycled products can lead to lower use and dependency on petrochemicals. The use of recycled products can also incentivize the reuse and recycling of materials. In certain embodiments, a blend includes a fiber composite blend such as a paper pulp blend. Different ratios of the materials are blended in order to provide strength, as well as to customize the color and aesthetics of the hard surface apparatus.

Certain embodiments of the present invention comprise methods of manufacturing a hard surface apparatus, such as a protective case. With reference to FIG. 1, in one embodiment, a method of manufacturing a hard surface apparatus includes the steps of processing fiber materials (1), blending fiber materials to create a slurry (2), spreading slurry material over a mold (3), drying the slurry material to form a molded material (4), applying certain coats to the molded material (5), and assembling the hard surface apparatus (6).

It should be understood that a variety of different fiber materials may be used to manufacture a hard surface apparatus in accordance with certain embodiments of the present invention, and particular steps may vary to suit particular fiber materials, which are preferably natural and/or recycled materials. In certain embodiments, materials, including, but not limited to cellulose-based materials (e.g., cardboard, cardboard products, paper, paper products, etc.), textiles, and loose or woven fibers such as basalt, flax, kenaf, coir, jute, bamboo, or hemp are processed. Cellulose-based materials may advantageously provide the hard surface apparatus with high strength, binding ability, and initial form rigidity (i.e. high manufacturability) at a relatively low cost. Basalt fiber material may advantageously provide reduced weight (as compared to cellulose-based materials), with high strength and durability. Flax linen fiber may provide the look of wood grain, but with higher strength and greater sustainability than wood. Other natural fibers may be selected for aesthetics or for other advantageous properties, including strength, availability, etc. In certain embodiments, synthetic fibers (e.g., aramid fibers, polyester fibers, fiberglass, etc.) may be used in combination with the natural and/or recycled materials to provide desired properties, including but not limited to color, strength, and weight.

Referring to FIG. 1, in certain embodiments, the manufacturing method includes processing fiber materials and, in the illustrated embodiment, cellulose-based materials (1). It will be appreciated that materials, involved with this processing step, are processed by fragmenting the large materials to small pieces. Fragmenting the materials is accomplished, for example, by mixing, shredding, tearing, mincing, and otherwise mechanically breaking apart the material.

The manufacturing method further includes blending the material to create a slurry (2). In certain embodiments, processed materials from the processing step are mixed with a solvent, such that the solvent dissolves or partially dissolves the processed material to create a slurry. In certain embodiments, the processed materials from the processing step are mixed with water to create a slurry. In certain embodiments, the water is heated to a temperature of between 25° C. to 100° C. In certain embodiments, the slurry is heated and mixed for a certain period of time. In certain embodiments, the moisture content of a slurry, prior to placing on the mold, is between 70-95% as measured with a moisture meter. It will be appreciated that mechanical devices including pulpers, blenders, and beaters are used to process and blend the fiber materials, for example, during the processing step and the blending steps.

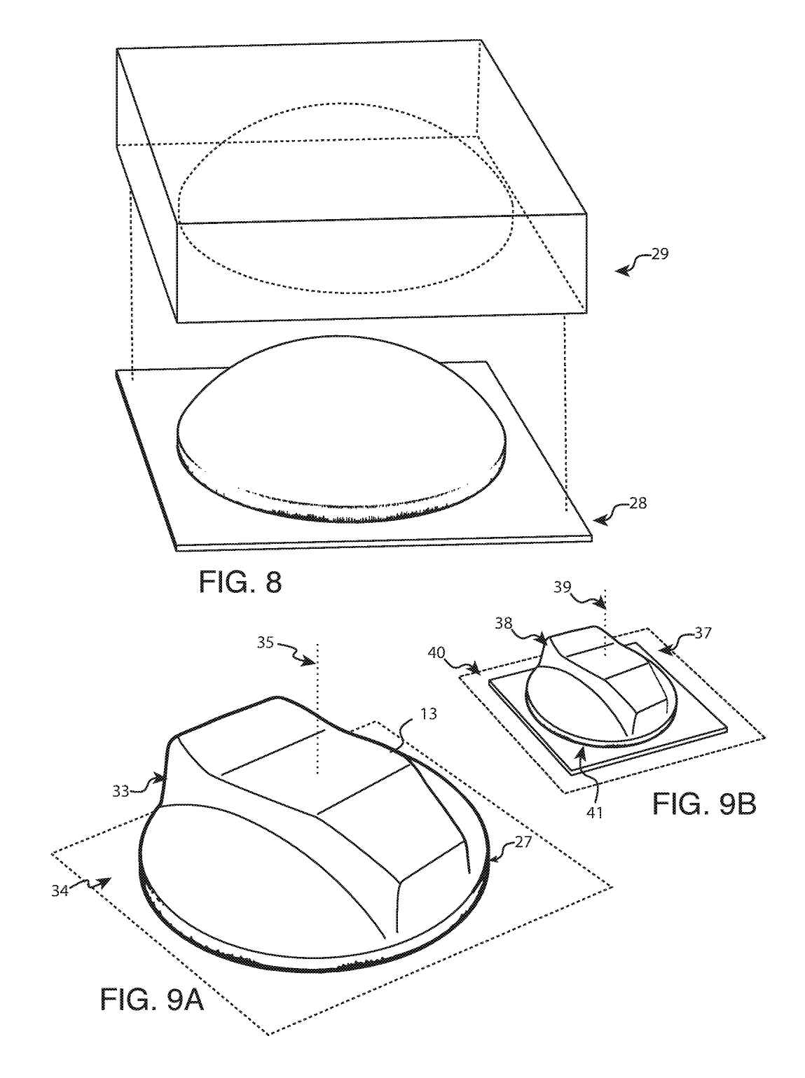

Still referring to FIG. 1, the manufacturing method includes spreading the slurry material over a mold (3). In certain embodiments, the slurry is placed on a positive mold, and spread over a surface of the positive mold. The slurry takes the form of an exemplary positive mold 28 (seen, for example, in FIG. 8). As the slurry is dried, the slurry takes the form of a molded material. In certain embodiments, a positive mold provides the shape for an interior surface 24 (seen, for example, in FIG. 4A-B) of a shell portion. In certain embodiments, a first mold has a shape to create a first shell portion, and a second mold has a shape to create a second shell portion.

In certain embodiments, excess solvent is removed from the slurry using an absorbent material. In certain embodiments, a mold includes a vacuum mold forming the shape of a molded material. In certain embodiments, a slurry is shaped by other types of molding techniques, including, but not limited to free molding, compression molding, and injection molding.

Still referring to FIG. 1 the manufacturing method includes drying the slurry material to form a molded material or a shell (4). In certain embodiments, the slurry is dried at a certain temperature and for a certain time in order to form a molded material or a shell. In certain embodiments, the slurry is dried at a temperature between the range of 25° to 52° C., and in certain embodiments, the slurry is dried at a temperature between the range of 25° to 100° C. In certain embodiments, the slurry is dried for five minutes to 48 hours. The drying time for the slurry may vary depending on the drying temperature and the equipment used to dry the slurry. It will be appreciated that other temperatures (for example, greater than 100° C.) and processing times can be used during this drying step. In certain embodiments, the slurry is dried to approximately 20%-50% dryness. In certain embodiments, the moisture content is measured to be less than 55% as measured with a moisture meter. In certain embodiments, drying includes the use of a heat press having a heating element to further dry the molded material and that can shape and press the slurry into the form of the mold. In certain embodiments, the heating element includes a heating surface that directly contacts the surface of the slurry/molded material. In certain embodiments, the heat press includes a negative mold 29 (seen, for example, in FIG. 8), where a negative mold provides the shape for an exterior surface 25 of a shell portion (seen, for example, in FIG. 4A-B). In certain embodiments, a positive mold 28 and/or a negative mold 29 are heated. In certain embodiments, a positive mold 28 and/or a negative mold 29 include a mesh material to allow airflow.

Once the slurry is dried, the molded material is reinforced with a coating. Still referring to FIG. 1, the manufacturing method includes applying certain coats to the molded material (5). In certain embodiments, a coat includes, but is not limited to, resins, terpenes, polymers, epoxy resins, polyester epoxies, polymer coating, and polyepoxides. It will be appreciated that in certain embodiments, the coating step includes applying, for example, a first layer, a second layer, a third layer, and an optional fourth layer of coating. In certain embodiments, the coating step includes applying more than four layers. In certain embodiments, the coating step includes applying a first layer and a second layer, and in certain embodiments, the coating step includes a first layer, second layer, and a third layer. In certain embodiments, each layer may include multiple applications of the same type of coat. In certain embodiments, each layer may include more than one applications of different types of coats.

In certain embodiments, a certain coat creates a permanent bond to the molded material and the previous layer. Once bonded, certain coats, as provided in certain embodiments, allows the hard case apparatus to have a durable base layer, and provides extreme impact protection and abrasion resistance, under certain use conditions. In certain embodiments, certain coats provide impact absorption, and resistance to damage by remaining both flexible and strong, without losing adhesion to a molded material. In certain embodiments, certain coats include a spray-on binding agent. Certain coats provide a barrier between equipment stored inside a hard case apparatus and exterior conditions, providing protection against conditions such as humidity, water, or extreme temperature changes. Certain coats provide a watertight, seamless barrier, which prevents rust or corrosion of certain items stored inside a hard case apparatus. In certain embodiments, certain coats are optionally an environmentally friendly material, for example, exhibiting low volatile organic compound (VOC) or VOC-free properties as determined by standardized testing. In certain embodiments, certain coats provide a durable UV resistant layer. In certain embodiments, certain coats have adhesion properties to a molded material, providing chemical resistance, fungus resistance, moisture protection, and the like.

Still referring to FIG. 1, the manufacturing method includes assembling the hard surface apparatus (6). In certain embodiments, various hardware elements are attached to the molded material during the assembly step. It will be appreciated that such hardware elements include, but is not limited to, straps, cushions, buckles, clasps, strings, buttons, snap buttons, laces, fabrics, rivets, drawstrings, padding, webbing, cords, zippers, hinges, locks, carabiners, wheels, hooks, rings, hook and loop, magnets (including magnetic latches), latex, foams (which may include latex foams such as Pure Green™, synthetic memory foam, or any other desired type of open or closed cell foam), rubber applications, and chlorosulfonated polyethylene (CSPE) synthetic rubber (CSM) applications such as Hypalon® (DuPont®). In certain embodiments, certain hardware elements used during assembly step have reduced emissions of potentially harmful VOCs. In certain embodiments, certain hardware elements are certified by independent testing and certification systems such as Ecolnstitut™, Okeo-Tex® and Greenguard Gold™, and the like.

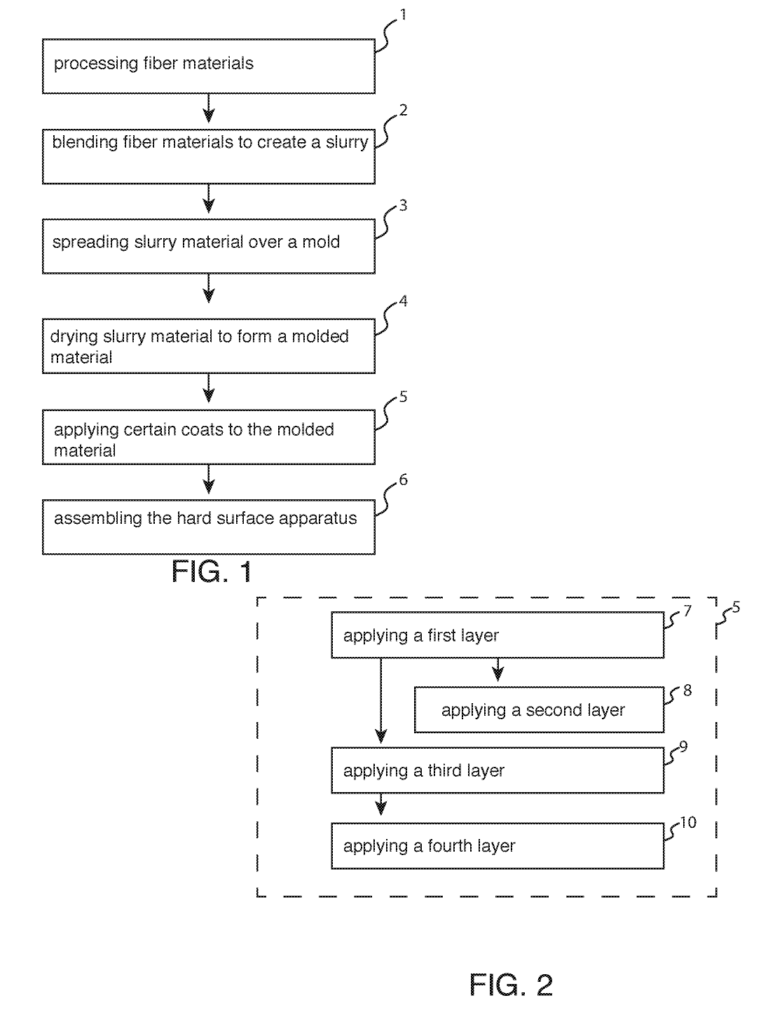

Referring to FIG. 2, in certain embodiments, the coating step comprises application of certain coats to the molded material. For example, as shown in FIG. 2, the coating step may further include applying a first layer (7), applying a second layer (8), applying a third layer (9), and applying a fourth layer (10). In certain embodiments, the coating step may also include curing the molded material at an elevated temperature after the application of one or more of the coating layers (7, 8, 9, 10). For example, the coated molded material may be placed in a curing oven for a predetermined time period based on an optimal curing time for a particular coating. Heat curing a particular coating may advantageously increase the heat resistance of the hard surface apparatus.

In certain embodiments, during the applying a first layer, the molded material from the drying step (FIG. 1, element 4) is treated with a first layer. In certain embodiments, a first layer exhibits adhesion to the base material or molded material. In certain embodiments, a first layer allows the hard case apparatus to have a durable base layer, and provides impact protection and abrasion resistance. In certain embodiments, a first layer is an environmentally friendly material, for example, exhibiting low VOC or VOC-free properties. In certain embodiments, a first layer provides a durable UV resistant layer. In certain embodiments, a layer includes, but is not limited to, resins, terpenes, polymers, epoxy resins, polyester epoxies, polymer coating, and polyepoxides. In preferred embodiments, a first layer includes an environmentally friendly epoxy coating provided by Ecopoxy® Coatings (Morris, MB, Canada). It will be appreciated that other types of epoxy, particularly environmentally friendly epoxy including, but not limited to, SuperSap® (Entropy Resins Inc., Hayward, Calif.) is used. The environmentally friendly epoxy coating preferably may include one or more plant-based oils in place of petro-chemical oils used in typical epoxies. It is an objective of certain embodiments of the present disclosure to replace the use of petro-chemicals and other chemicals with recycled, reused, and/or environmentally friendly materials for the production of a hard case apparatus found in certain embodiments. The use of recycled, reused, and/or environmentally friendly materials reduces the carbon footprint, and reduces greenhouse emissions. By using coatings that are more environmentally friendly, negative impacts on the environment can be reduced. Furthermore, using coatings that are environmentally friendly create a healthier and safer work environment when applying such coatings.

After application of a first layer, in certain embodiments, a molded material is further processed. In certain embodiments, surfaces of a molded material is smoothed or abraded with, for example, a sanding tool. Sanding refines the surfaces and edges of the molded material.

Still referring to FIG. 2, during applying a second layer (8), the molded material is treated with a second layer. In certain embodiments, the molded material is further reinforced with a liner or a spray-on binding agent. In certain embodiments, a liner includes a flexible material that adheres to the previous layer. In certain embodiments, a second layer includes a spray-on binding agent, for example, a polyurethane, polyurea, and a polyurethane/polyurea hybrid material. In certain embodiments, a second layer provides a seal for a first layer. In certain embodiments, a second layer is optionally an environmentally friendly material, for example, exhibiting volatile organic compound (VOC)-free properties. In certain embodiments, a second layer provides a durable UV resistant layer. In certain embodiments, a second layer provides a barrier between equipment stored inside a hard case apparatus and exterior conditions, providing protection against conditions such as humidity, water, or extreme temperature changes. A second layer includes, for example, a two-component polyurea/polyurethane hybrid spray elastomer coating. The coating may be formed by spraying an isocyanate component and a polymer component on to the molded material using a mixing sprayer. In preferred embodiments, the coating includes a formulation provided by Line-X® (Line-X, LLC, Huntsville Ala.), as described in U.S. Pat. No. 9,469,798 to Le et al., U.S. patent application Ser. No. 14/022,128 to Le et al., U.S. patent application Ser. No. 12/880,048 to Le et al., and U.S. Provisional Patent Application No. 61/241,294 to Le et al., which are incorporated herein by reference in their entirety. In certain embodiments, a second layer includes a protective coating produced by Rhino Linings® (Rhino Linings Corporation, San Diego, Calif.). In certain embodiments, a second layer includes a protective coating produced by Sprayroq® Protective Lining System (Sprayroq Inc., Irondale, Ala.). In certain embodiments, a second layer includes a protective coating produced by Toff® Sprayed on Bed Liners (Artlux Inc., Dallas, Tex.). It will be appreciated that in certain embodiments, a second layer includes other types of binding agent or liners (also referred to as spray-on liners). The property of certain binding agent or liners allows the hard case apparatus to be held together by a layer exhibiting flexible properties. In certain embodiments, a binding agent or liner allows the hard case apparatus to be less prone to shattering. In certain embodiments, a second layer provides impact absorption, and resistance to damage by remaining both flexible and strong, without losing adhesion to a previous layer. It will be appreciated that a second layer also includes, for example, resins, terpenes, polymers, epoxy resins, polyester epoxies, polymer coating, and polyepoxides.

After application of a second layer, in certain embodiments, a molded material is further processed. In certain embodiments, surfaces of a molded material is smoothed or abraded with, for example, a sanding tool. Sanding refines the surfaces and edges of the molded material.

In certain embodiments, a third layer is applied. For example, referring to FIG. 2, molded material is further treated with a third layer (9). A third layer includes a protective layer that provides a permanent bond to a previous layer. Once bonded, a third layer, as provided in certain embodiments, allows the hard case apparatus to have a durable layer, and provides extreme impact protection and abrasion resistance, under certain use conditions. A third layer provides a barrier between equipment stored inside a hard case apparatus and exterior conditions, providing protection against conditions such as humidity, water, or extreme temperature changes. In certain embodiments, a third layer provides a watertight, seamless barrier, which prevents rust or corrosion of certain items stored inside a hard case apparatus. In certain embodiments, a third layer is optionally an environmentally friendly material, for example, exhibiting volatile organic compound (VOC)-free properties. In certain embodiments, a third layer provides chemical and fungus resistance, moisture protection. It will be appreciated that a third layer includes, for example, resins, terpenes, polymers, epoxy resins, polyester epoxies, polymer coating, and polyepoxides. In certain embodiments, a third layer includes an epoxy coating provided by Ecopoxy® Coatings (Morris, MB, Canada). It will be appreciated that other types of epoxy, particularly environmentally friendly epoxy including, but not limited to, SuperSap® (Entropy Resins Inc, Hayward, Calif.) is used for a third layer.

After application of a third layer, a molded material can be further processed. In certain embodiments, surfaces of a molded material is smoothed or abraded. Sanding refines the surfaces and edges of the molded material.

After application of a third layer, (9), a fourth layer can be applied. Referring to FIG. 2, the molded material is further treated with a spray-on binding agent (10). However, it will be appreciated that other types of coatings can be used as a fourth layer. In certain embodiments, the fourth layer includes, but is not limited to, a liner or a spray-on binding agent. In certain embodiments, a liner includes a flexible material that adheres to the previous layer. In certain embodiments, a fourth layer includes a polyurea/polyurethane hybrid elastomer coating, such as a formulation provided by Line-X® (Line-X, LLC, Huntsville Ala.), Rhino Linings® (Rhino Linings Corporation, San Diego, Calif.), Sprayroq® Protective Lining System (Sprayroq Inc., Irondale, Ala.), and Toff® Sprayed on Bed Liners (Artlux Inc., Dallas, Tex.). Referring to FIG. 4C, in certain embodiments, a fourth layer is applied to a portion of an exterior surface 25, for example, around the lip or edges of a shell portion 19. It will be appreciated that in certain embodiments, a fourth layer includes other types of spray-on binding agent. It will be appreciated that a fourth layer also includes, for example, resins, terpenes, polymers, epoxy resins, polyester epoxies, polymer coating, and polyepoxides.

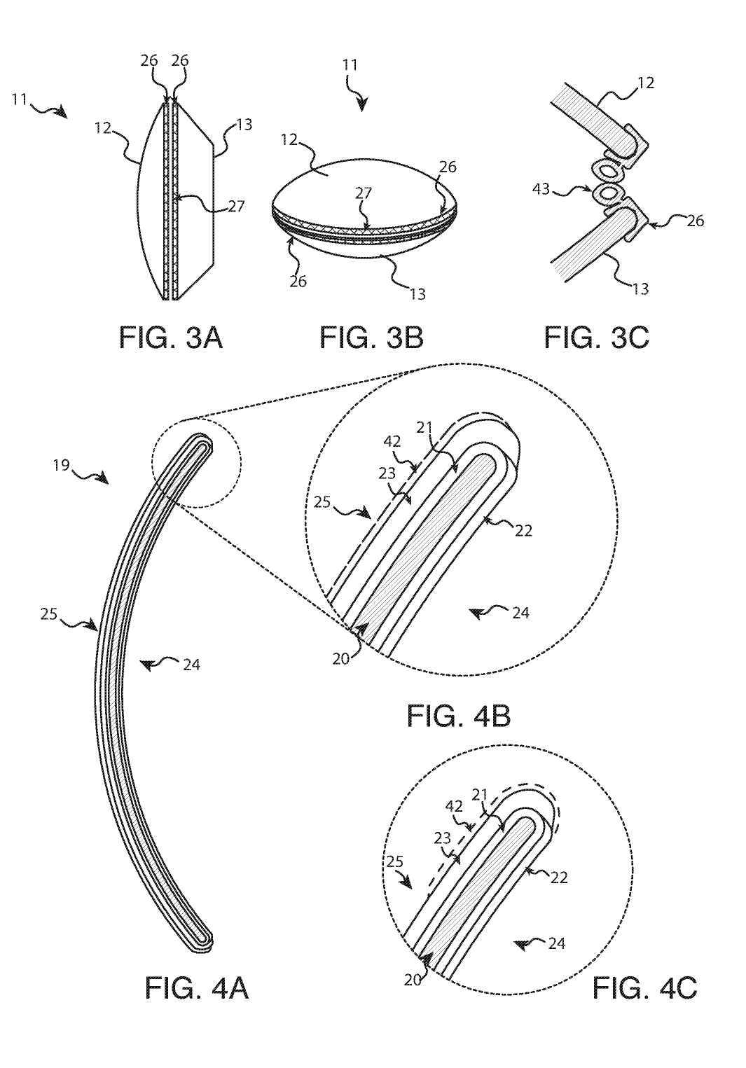

In certain embodiments, a weather strip is applied to a hard case apparatus. In certain embodiments, a weather strip, such as a rubber seal is applied near the opening of hard case apparatus. As seen in FIG. 3A-B, an embodiment of a hard case apparatus 11 includes a first shell portion 12 and a second shell portion 13. In certain embodiments, a first shell portion 12 and a second shell portion 13 join at a lip 27. Separation of the first shell portion 12 and a second shell portion 13 allows access to an interior space of the hard case apparatus 11. In certain embodiments, a rubber seal 26 is applied surrounding an area located proximal to the lip 27. A rubber seal 26 creates cushioning for impact resistance, and a moisture barrier between a first portion 12 and a second portion 13 of a hard case apparatus. In certain embodiments, a rubber seal 26, as shown in FIG. 3C, includes a bulb portion 43 to assist in impact resistance and as a moisture barrier. In certain embodiments, an additional epoxy layer is applied after a rubber seal is placed on a hard case apparatus.

Referring to FIG. 4A-B, an embodiment of a shell portion 19 of a hard case apparatus is provided. In certain embodiments, a shell portion 19 further includes a curved form, further defining an interior surface 24 and an exterior surface 25. It will be appreciated that a first shell portion and a second shell portion are examples of a shell portion. It will be appreciated that in certain embodiments, a hard case apparatus includes one or more shell portions. In certain embodiments, while coating (FIG. 2), a first layer 21 is applied to a molded material 20. In certain embodiments, a first layer 21 is applied to an interior surface 24 and an exterior surface 25 of a molded material 20. The first layer 21 contacts and interacts with the molded material 20. In certain embodiments, a second layer 22 is applied to a molded material 20. In certain embodiments, a second layer 22 is applied to an interior surface 24 of the molded material 20 as shown in FIG. 4A-B. In certain embodiments, during step 9 shown in FIG. 2, a third layer 23 is applied to a molded material 20. In certain embodiments, a third layer 23 is applied to an exterior surface 25 of a molded material 20 as shown in FIG. 4A-B. Between the layers 21, 22, 23, an interior surface 24 and an exterior surface 25 is optionally smoothed or abraded. In certain steps, during step 10 shown in FIG. 2, an optional fourth layer 42 is applied after the third layer 23 as shown in FIG. 4A-B. In certain embodiments, a layer that includes a binding agent or liner is applied as the most-exterior layer.

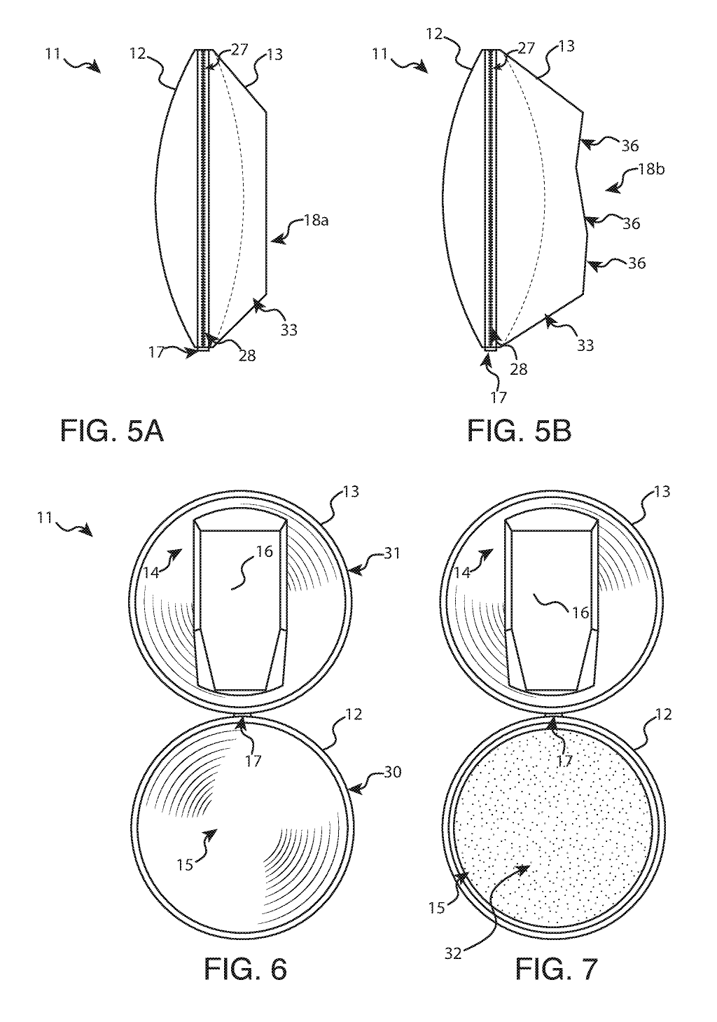

Referring to FIG. 1, in certain embodiments, various hardware elements are attached to the molded material during assembly (6). As shown in FIGS. 5A-B, and 6, an embodiment of a hard case apparatus 11 includes a hinge 17. Certain embodiments of a hard case apparatus include one or more hinges. In certain embodiments, a hinge made of materials, including, but not limited to, metal, plastic, and fabric. In certain embodiments, a hinge is detachable, allowing a first portion and a second portion of a hard case apparatus to detach. In certain embodiments, a hinge 17 includes a Hypalon® fabric material. The hinge 17 allows hingeable opening of a first shell portion 12 and a second shell portion 13. In certain embodiments, a first shell portion 12 and a second shell portion 13 are sealed with a closing means, including, but not limited to, clasps, buttons, snap buttons, hook and loop, and laces. Referring to FIGS. 5A-B, 6, and 7, in certain embodiments, a zipper 28 portion is attached to a perimeter 30 of an opening of a first shell portion 12 and to a perimeter 31 of an opening of a second shell portion 13. Certain embodiments use a water-resistant zipper. Certain embodiments use a water-resistant zipper provided by YKK® (YKK Group, Tokyo, Japan). During assembly, for example, a zipper is sewn onto a webbing. Holes are drilled into the perimeter of a shell opening, located near the lip 27 of a shell portion. The webbing is sewn into the drilled holes. In certain embodiments, the zippers 28 seen in FIG. 3A-B are attached to the shell, surrounding the rubber seal seen in FIG. 3C. An additional coating is applied to the webbing to further seal the zipper to the shell portion.

In certain embodiments, a shell portion of a hard case apparatus 11 includes a back surface. As seen in FIGS. 5A-B, a second shell portion 13 includes a back surface 18a, 18b. However, it will be appreciated that in certain embodiments, a second shell portion lacks a protrusion. In certain embodiments, a second shell portion and/or first shell portion include other features including, but not limited to, a dome shaped curvature, cylindrical features, square features, cuboid features, dome features, conical features, and frustoconical features. In certain embodiments, a first shell portion and second shell portion mirror each other. In certain embodiments, a first shell portion and second shell portion are symmetrical about an adjoining plane. In certain embodiments, the first shell portion and the second shell portion may not be symmetrical and may overlap in various ways. In certain embodiments, a back surface allows attachment of hardware elements. It will be appreciated that hardware elements are attached to a second shell portion 13, and in some cases, to a first shell portion 12 with, for example, fasteners (e.g. bolts and nuts), adhesive, sealant, and by sewing, but is not limited to these methods. In certain embodiments, a back surface 18a includes a planar surface. In certain embodiments, a back surface 18b includes an ergonomic surface. In certain embodiments, a back surface 18b includes a surface that generally matches the contour of certain aspects of a user's spine. In certain embodiments, back surface 18b includes one or more planar surfaces 36 located on a back surface 18b. In certain embodiments, supportive materials, including but not limited to, mesh, padding, foam, fabric, and cushions are placed on a back surface 18a, b.

In certain embodiments, as seen for example in FIG. 6, a hard case apparatus 11 can be opened, where a first shell portion 12 and a second shell portion 13 are attached at a hinge 17. In certain embodiments, a hinge is optionally detachable. Referring to FIG. 6, an interior surface 15 of a first shell portion 12 and an interior surface 14 of a second shell portion 13 are shown. In certain embodiments, referring to FIG. 9A, a hard case apparatus includes a shell portion 13 that defines an adjoining plane 34, where the adjoining plane is coplanar with a lip 27. As such, in the illustrated embodiment, it will be appreciated that the first shell portion 12 and the second shell portion 13 join together at the adjoining plane 34. In other embodiments, a lip 27 on one of the first shell portion 12 or the second shell portion 13 may completely or partially overlap a lip 27 on the other of the first shell portion 12 or the second shell portion 13. In such embodiments, the overlapping lip 27 may at least partially cover the interface between the first shell portion 12 and the second shell portion 13, which may improve aerodynamics, weather resistance, etc. Still referring to FIG. 9A, a shell portion, for example, second shell portion 13, defines an axis 35 that is perpendicular to the adjoining plane 34. In certain embodiments, a second shell portion 13 includes a protrusion 33 that extends generally in a direction that is parallel to the axis 35, and away from the adjoining plane 34. Referring to FIG. 6, an interior aspect of the second shell portion 13 includes a cavity 16 located on the inner aspect of the protrusion 33 shown in FIG. 9A.

Referring to FIG. 9B, in certain embodiments, a mold 37 for a second shell portion includes a protrusion 38 that extends generally in a direction that is parallel to an axis 39, where such axis 39 is perpendicular to a plane 40 that is coplanar with the lower surface 41 of a mold 37.

In certain embodiments, an interior surface 14, 15, and a cavity 16 includes supportive materials, although in certain embodiments, it can be appreciated that an interior aspect of a first and second shell portion lacks supportive materials. Referring to FIG. 7, in certain embodiments, an interior of a shell portion holds supportive materials protect items placed inside a hard case apparatus. In certain embodiments, supportive materials 32 (shown, for example, in FIG. 7) include, for example, synthetic memory foam, closed cell foam, and natural latex foam. In certain embodiments, a latex foam such as Pure Green™ latex foam is used. In certain embodiments, the foam includes a thickness that is adapted to support and protect the contents. In certain embodiments, the supportive materials are adjustable for different kinds of content. In certain embodiments, a fabric liner covers the foam.

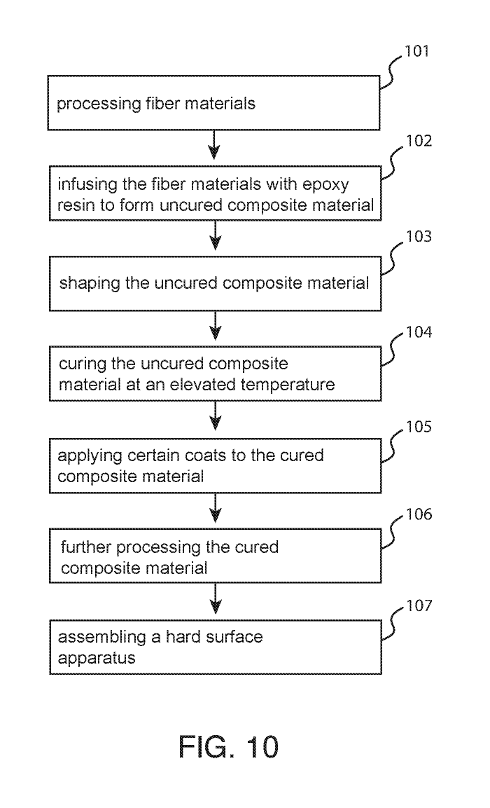

FIG. 10 illustrates a method of manufacturing a hard surface apparatus, such as a protective case or hard case apparatus, according to another embodiment. The illustrated method also allows the creation of hard surface apparatuses such as kayaks and canoes, flooring and tiles, kitchen ware, sinks and bathtubs, and the like. The illustrated method includes processing fiber materials (101), infusing the fiber materials with epoxy resin to form uncured composite material (102), shaping the uncured composite material (103), curing the uncured composite material at an elevated temperature (104), applying certain coats to the cured composite material (105), further processing the cured composite material (106), and assembling the hard surface apparatus (107). The method illustrated in FIG. 10 is similar to the method illustrated in FIG. 1. One or more of the steps of the method illustrated in FIG. 1 may also or alternatively be included in the method of FIG. 10. Likewise, one or more of the steps of the method illustrated in FIG. 10 may also or alternatively be included in the method of FIG. 1.

Referring to FIG. 10, in certain embodiments, the manufacturing method includes processing fiber materials (101), and in the illustrated embodiment, strand-based fiber materials such as basalt fiber, flax, kenaf, coir, jute, bamboo, or hemp. Either one type or multiple types of materials may be used. It will be appreciated that materials involved with this processing step are processed by arranging and orienting the strands of the materials in a desired pattern, such as a parallel pattern or a woven pattern. The materials may be arranged in a single layer or stacked in multiple layers. Arranging and orienting the strands of the materials may be performed by hand or by an automated system.

The illustrated method further includes infusing the fiber materials with epoxy resin to form an uncured composite material (102). In certain embodiments, an environmentally friendly epoxy coating such as Ecopoxy®, SuperSap®, or any other environmentally friendly epoxy resin suitable for use in a hard surface apparatus may be used. The infusing step 102 may be performed by vacuum infusion in certain embodiments. In such embodiments, the fiber materials may be enclosed in an impermeable bag, a vacuum pump coupled to the bag, and air pumped out of the bag by the vacuum pump. Either before or during operation of the vacuum pump, the epoxy resin is introduced to the bag. The epoxy resin permeates through the fiber materials to infuse the fiber materials with the epoxy resin. In other embodiments, the infusing step may be performed in other ways, including but not limited to compression molding, or infusion/injection molding.

With continued reference to FIG. 10, the illustrated method further includes shaping the uncured composite material (103) and curing the uncured composite material at an elevated temperature (104). In certain embodiments, shaping may include pressing the uncured composite into a first mold to create a first shell portion (e.g., shell portion 12 illustrated in FIGS. 3A-3C) and into a second mold to create a second shell portion (e.g., shell portion 13 illustrated in FIGS. 3A-3C). The uncured composite may be shaped by various molding techniques, including, but not limited to free molding, compression molding, vacuum molding, and injection molding. After shaping, the composite material is cured at an elevated temperature in a curing oven for a predetermined time period. In certain embodiments, the composite material may be cured at a temperature of at least 150 degrees Fahrenheit. In certain embodiments, the composite material may be cured at a temperature between 100 degrees Fahrenheit and 300 degrees Fahrenheit. In certain embodiments, the composite material may be cured using a varying temperature profile, such that the curing temperature varies with time.

In certain embodiments, both curing and shaping may occur simultaneously using a heat press having a heating element and that can shape and press uncured composite material in the form of the mold. In certain embodiments, the heating element includes a heating surface that directly contacts the surface of the uncured composite material. In certain embodiments, the heat press includes a negative mold 29 (seen, for example, in FIG. 8), where a negative mold provides the shape for an exterior surface 25 of a shell portion (seen, for example, in FIG. 4A-B). In certain embodiments, a positive mold 28 and/or a negative mold 29 are heated.

Once the composite material is cured, it is reinforced with a coating at step 105. This step is similar to the coating step 5 described above with reference to FIGS. 1 and 2, and the processes, coatings, and various alternatives described above may similarly be applied to the coating step 105. After coating, further processing the cured composite material occurs at step 106. Step 106 may include sanding and polishing, attaching various hardware elements, and/or any of the other further processing steps described above. Finally, coated and processed composite material is assembled into a hard surface apparatus, such as the protective hard case apparatus 11 described above with reference to FIGS. 5A-7 (e.g., by coupling the first shell portion 12 to the second shell portion 13).

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

Various features of the invention are set forth in the following claims.

What is claimed is:

1. A method for manufacturing a hard surface apparatus, the method comprising the steps of:
processing a material comprising a cellulose-base, wherein the processing step comprises fragmenting the material;
blending the material,
adding a solvent and mixing the solvent with the material to create a slurry;
molding the slurry on a first mold;
drying said slurry on the first mold to create a first molded material;
applying a first layer to the first molded material; and
applying a second layer to the first molded material.

2. The method in claim 1, wherein the processing step comprises processing a recycled product.

3. The method in claim 1, wherein said first layer comprises epoxy resin.

4. The method in claim 3, wherein the first layer further comprises a plant-based oil.

5. The method in claim 1, wherein the second layer comprises a polyurea/polyurethane hybrid coating.

6. The method in claim 5, wherein applying the second layer further comprises spraying a mixture of an isocyanate component and a polymer resin component to form the polyurea/polyurethane hybrid coating on the first molded material.

7. The method in claim 1, further comprising;
molding a second slurry on a second mold;
drying the second slurry on the second mold to create a second molded material;
applying a first layer to the second molded material;
applying a second layer to the second molded material; and
assembling the first molded material and the second molded material.

8. The method in claim 1, further comprising applying a third layer to the first molded material.

9. The method in claim 1, further comprising applying a fourth layer to the first molded material.

10. The method in claim 10, wherein applying the fourth layer further comprises applying a polyurea/polyurethane hybrid coating to the first molded material.

11. A method for manufacturing a protective case, the method comprising the steps of:
processing a recycled material comprising a cellulose-base;
adding a solvent and mixing the solvent with the material to create a slurry;
molding the slurry on a first mold to create a first molded material;
applying a first layer to the first molded material; and
applying a second layer to the first molded material.

12. The method in claim 11, wherein said first layer comprises epoxy resin, and wherein the second layer comprises a polyurea/polyurethane hybrid coating.

13. The method of claim 11, further comprising heating the first molded material after applying the first layer to cure the first layer.

14. The method of claim 11, further comprising
molding a second slurry on a second mold to create a second molded material;
applying a first layer to the second molded material;
applying a second layer to the second molded material; and
coupling the first molded material to the second molded material.

15. A method for manufacturing a protective case, the method comprising the steps of:
forming a first shell and a second shell, wherein forming each of the first and second shells includes
infusing a natural fiber base material with an epoxy resin to form an uncured composite material,
shaping the uncured composite material, and
curing the uncured composite material at an elevated temperature to form a cured composite material; and
after curing, coupling the first shell to the second shell.

16. The method of claim 15, wherein curing includes pressing the uncured composite material in a heat press.

17. The method of claim 15, wherein the natural fiber base material is selected from a group consisting of cellulose-based material, basalt fiber, flax, kenaf, coir, jute, bamboo, and hemp.

18. The method of claim 15, wherein coupling the first shell to the second shell includes attaching a hinge to the first shell and the second shell.

19. The method of claim 15, wherein infusing includes enclosing the natural fiber base material and the epoxy resin in a bag, coupling a vacuum pump to the bag, and pumping air out of the bag with the vacuum pump.

20. The method of claim 15, wherein forming each of the first and second shells further includes, after curing, spraying a protective coating on the cured composite material.
